(19) United States
(12) Patent Application Publication
(10) Pub. No.: US 2018/0231782 A1
(43) Pub. Date: Aug. 16, 2018

(54) LENS, OPTICAL DEVICE, AND HEAD MOUNTED DISPLAY DEVICE FOR IMPLEMENTING VIRTUAL REALITY COMPRISING SAME

(71) Applicant: LG Innotek Co., Ltd., Seoul (KR)

(72) Inventors: JAE WOOK JUNG, Seoul (KR); SUNG PHIL KIM, Seoul (KR); SANG JUN PARK, Seoul (KR); GI SEOK LEE, Seoul (KR); YANG HYUN JOO, Seoul (KR)

(21) Appl. No.: 15/750,443

(22) PCT Filed: Aug. 1, 2016
(86) PCT No.: PCT/KR2016/008426

§ 371 Date: Feb. 5, 2018

(30) Foreign Application Priority Data
Aug. 4, 2015 (KR) 10-2015-0110004
Apr. 21, 2016 (KR) 10-2016-0048983

(51) Int. Cl. G02B 27/01; G02B 3/08; H04N 13/332; G06T 19/00

(52) U.S. Cl. CPC G02B 27/0172; G06T 19/006; H04N 13/332; G02B 3/08

(57) ABSTRACT

An embodiment provides a lens comprising: a first surface; and a second surface that faces the first surface, wherein the second surface comprises a plurality of optical path conversion units, each of the plurality of optical path conversion units comprises first and second portions, which have different inclinations with regard to a first axis that is perpendicular to the first surface, and the height of an optical light path conversion unit, which is arranged on the center portion of the second surface, along the first axis is different from the height of an optical path conversion unit, which is arranged on the peripheral portion thereof, along the first axis.

### TECHNICAL FIELD

Embodiments relate to an optical device and a display apparatus including the same, and more particularly, to a head-mounted display apparatus for implementing virtual reality.

### BACKGROUND ART

A head-mounted display apparatus for implementing virtual reality is an apparatus that a user wears like a pair of glasses to view an image. The head-mounted display apparatus may also be called a face-mounted display (FMD).

For the first time, such a glasses-type monitor has been developed and used for military purposes. However, the glasses-type monitor has also increasingly come to be used for civilian purposes due to improvements in the performance of computer systems, the reduction in size of computer systems, the development of display apparatuses, such as a liquid crystal display (LCD), and the development of image and communication technology.

In particular, it is expected that, as the result of the development of a wearable computer or a smartphone, the glasses-type monitor will be popularized as a personal display apparatus for the wearable computer.

In the head-mounted display apparatus for implementing virtual reality, a lens may be configured such that at least one surface of the lens is convex. In order to improve the performance of the head-mounted display apparatus for implementing virtual reality, the focal distance of the lens must be short. As a result, the lens may be thickened, and the distance between the lens and the display unit may increase, whereby the overall volume of the head-mounted display apparatus may increase.

The head-mounted display apparatus may be worn on the head of a user in order to implement augmented reality or virtual reality outdoors.

A conventional virtual reality display apparatus has an advantage in that an image can be displayed in a large space in front of the eyes of the user, but has a problem in that the user cannot view the actual environment. In addition, a conventional augmented-reality display apparatus has an advantage in that the user can view the actual environment, but has a problem in that it is not possible to implement a display of the kind provided by the virtual-reality display apparatus.

### DISCLOSURE

### Technical Problem

Embodiments provide a head-mounted display apparatus for implementing virtual reality configured such that the angle of view of an optical device is increased while the weight and volume of the optical device are reduced.

Embodiments provide a head-mounted display apparatus for implementing virtual reality that is capable of displaying an image in a large space in front of the eyes of a user and that enables the user to view the actual environment.

In addition, embodiments provide a head-mounted display apparatus for implementing virtual reality configured to have the same angle of view as the eyes of a user.

### Technical Solution

In one embodiment, a lens includes a first surface and a second surface opposite the first surface, wherein the second surface includes a plurality of optical path conversion units, each of the optical path conversion units includes a first part and a second part having different inclinations with respect to a first axis perpendicular to the first surface, and the height of an optical path conversion unit disposed at the central part of the second surface in a first-axis direction is different than the height of an optical path conversion unit disposed at the peripheral part of the second surface in the first-axis direction.

Each of the optical path conversion units may have a circular shape.

The optical path conversion units may be disposed so as to have the same center.

The first part may be parallel to the first axis.

The second part may have a curvature.

The height of each of the optical path conversion units may gradually increase from the central part to the peripheral part.

The center of the optical path conversion units, which constitute concentric circles, may be spaced apart from the center of the second surface.

The lens may include a pair of lenses, and the centers of the optical path conversion units of the lenses may be spaced apart from each other in opposite directions.

The widths of the optical path conversion units may be uniform.

Each of the optical path conversion units may have a width of 10 μm to 1 mm.

Each of the optical path conversion units may have a height of 0.5 mm or less.

The size of the lens may be equal to or less than the size of the panel

In another embodiment, an optical device includes the lens and a fixing holder for fixing the lens, wherein the fixing holder includes a location part for allowing a display unit to be disposed thereon.

The size of the lens may be equal to or less than the size of the display unit.

The distance from the first surface of the lens and the display unit may be less than ⅔ of the size of the display unit.

The lens may include two lenses, and the optical axes of the lenses may be inclined with respect to each other.

The lens may include two lenses, the display unit may include two display units, and the display units may be disposed so as to be perpendicular to the optical axes of the lenses.

The optical axes of the lenses may be inclined such that the angle between the optical axes is 60 degrees or less.

In another embodiment, a head-mounted display apparatus for implementing virtual reality includes the lens, a display unit disposed so as to be spaced apart from the second surface of the lens, a fixing holder for fixing the lens to the display unit, a circuit board for supplying a signal to the display unit, and a main body for receiving the fixing holder and the circuit board therein.

In another embodiment, an optical device includes a lens unit comprising at least one Fresnel lens and a fixing holder for fixing the lens unit, wherein the fixing holder includes a display location part for allowing a display unit to be coupled thereto.

In another embodiment, a head-mounted display apparatus for implementing virtual reality includes the optical device, a circuit board for supplying a signal to the display unit, and a main body for receiving the fixing holder and the circuit board therein, wherein the display unit is disposed on the display location part so as to be spaced apart from the Fresnel lens.

In a further embodiment, a display apparatus includes a holding unit for providing a space in which the head of a user is held, a display unit for providing an image to the user, and a coupling unit for coupling the holding unit and the display unit, wherein the display unit includes a body, which defines the external appearance thereof, a panel provided at the body for displaying image information to be displayed to the user, a lens unit provided inside the body for transmitting the image information displayed on the panel to the user, and a camera unit provided at the front of the body for photographing an external image.

The camera unit may include a first camera provided on the left side of the body and a second camera provided on the right side of the body.

The first camera may be configured to have a first wide angle, and the second camera may be configured to have a second wide angle.

The first wide angle and the second wide angle may be the same as each other.

The first wide angle and the second wide angle may be different from each other.

The lens unit may include a first lens disposed on the left side of the inner surface of the body and a second lens disposed on the right side of the inner surface of the body.

Each of the first lens and the second lens may be a fisheye lens.

The display apparatus may further include a wireless communication unit connected to the display apparatus for exchanging various kinds of control signals using a wireless communication protocol, a wired communication unit for exchanging a signal with another control device, an information provision unit for providing various kinds of image information, a sound output unit for outputting a sound signal, and a controller for controlling the wireless communication unit, the wired communication unit, the sound output unit, and the display unit.

The information provision unit may include a first information provision part for providing information about a message received by a mobile phone.

The information provision unit may include a second information provision part for providing information about current temperature and humidity.

The information provision unit may include a third information provision part for providing information about the current date.

### Advantageous Effects

In the lens, the optical device, and the head-mounted display apparatus for implementing virtual reality including the same according to the embodiments, the volume of the lens may be reduced, and the angle of view of the optical device may be increased while the weight and volume of the optical device are reduced.

In addition, an image may be displayed in a large space in front of the eyes of the user, and at the same time the user may be capable of viewing the actual environment.

In addition, it is possible to provide the same angle of view as the eyes of the user.

### DESCRIPTION OF DRAWINGS

FIG. 1a is a perspective view showing an embodiment of a head-mounted display apparatus for implementing virtual reality;

FIG. 2 is an exploded perspective view showing an optical device of FIG. 1;

FIGS. 3a and 3b are, respectively, a perspective view and a rear view showing the optical device of FIG. 1;

FIGS. 3c and 3d are views respectively showing openings in a first region and a second region of a fixing holder;

FIG. 4 is a detailed view showing a lens and a display unit of FIG. 1;

FIGS. 5a to 5d are views showing the principle of the lens;

FIGS. 6a to 6c are detailed views showing a second surface of the lens;

FIGS. 7a and 7b are views showing the shape of edge regions of the lens;

FIGS. 8a to 8g are views showing other embodiments of the lens;

FIG. 9 is a view showing the principle by which beams passing through the lens converge;

FIGS. 10a to 10d are views showing the principle by which beams converge at each region of the lens;

FIGS. 11a to 11d are detailed views showing the arrangement of a pair of lenses and display units;

FIGS. 12a to 12c are perspective views schematically showing another embodiment of the head-mounted display apparatus for implementing virtual reality;

FIG. 13 is a detailed view showing the head-mounted display apparatus for implementing virtual reality of FIGS. 12a to 12c;

FIGS. 14a and 14b are views showing a scene displayed to a user through the head-mounted display apparatus for implementing virtual reality of FIG. 13; and

FIG. 15 is a block diagram showing the structure of the head-mounted display apparatus for implementing virtual reality of FIG. 13.

### BEST MODE

Reference will now be made in detail to embodiments, examples of which are illustrated in the accompanying drawings.

In the following description of the embodiments, it will be understood that, when each element is referred to as being “on” or “under” another element, it can be “directly” on or under another element, or can be “indirectly” disposed in relation thereto such that an intervening element is present therebetween. In addition, when an element is referred to as being ‘on’ or ‘under’, ‘under the element’ as well as ‘on the element’ can be included based on the element.

In the following description, that an object has a slope of infinity or a slope of 0 may mean that the object is substantially inclined, and a slope of infinity or 0 may be compared with slopes having different constant values.

In addition, relational terms, such as “first,” “second,” “on/upper part/above” and “under/lower part/below,” are used only to distinguish between one subject or element and another subject and element, without necessarily requiring or involving any physical or logical relationship or sequence between such subjects or elements.

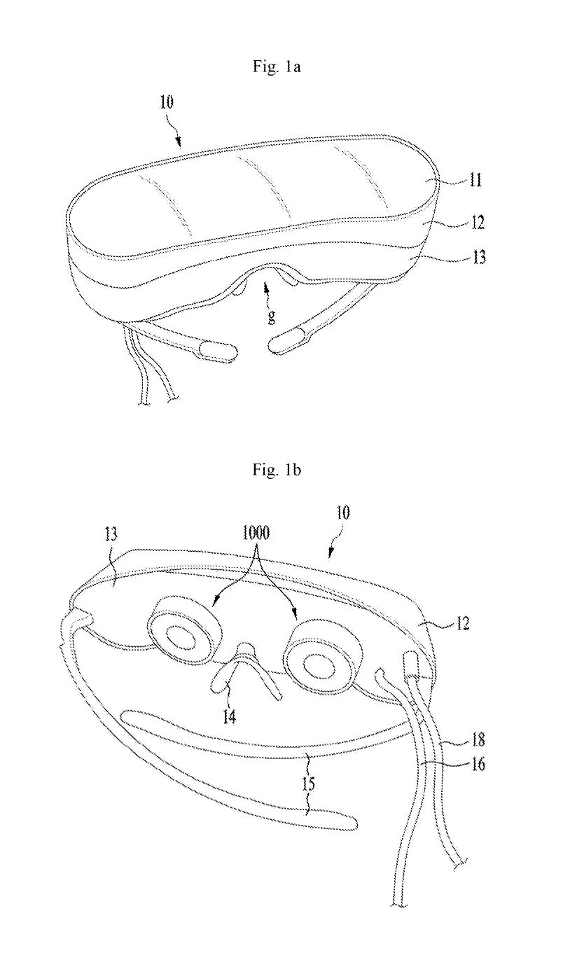

FIG. 1a is a perspective view showing an embodiment of a head-mounted display apparatus for implementing virtual reality.

The head-mounted display apparatus 10 for implementing virtual reality according to the embodiment may include a main body 12 and a pair of optical devices 1000 disposed on the main body 12.

The optical devices 1000 may be disposed at one side of the main body 12. A first support unit 14, which is supported by the nose of a user, may be disposed between the optical devices 1000. A side shielding unit 13 may be disposed at the edge of the main body 12. A front shielding unit 11 may be disposed at the other side of the main body 12. A user who wears the head-mounted display apparatus 10 for implementing virtual reality may clearly view an image displayed on a display unit in the state in which external light is prevented from being introduced into the head-mounted display apparatus by the operation of the front shielding unit 11 and the side shielding unit 13.

The main body 12 may serve as a frame of the head-mounted display apparatus 10 for implementing virtual reality. Consequently, the main body 12 may be made of a material that is rigid and non-fragile, such as metal or ceramic.

The front shielding unit 11, which is provided at the other side, i.e. the front, of the main body 12, and the side shielding unit 13, which is provided at one side of the main body 12, may be made of a material that is capable of blocking external light, and may be formed in a shape that is capable of blocking external light. In particular, a groove g may be formed in the side shielding unit 13 so as to be supported by the nose of the user.

Second support units 15, which are connected to the main body 12 or the side shielding unit 13 and which are supported by the ears of the user, may be disposed outside the optical devices 1000.

A first cable 16 may be connected to the optical devices 1000 in order to supply a driving signal to display units in the optical devices 1000, a description of which will follow.

A second cable 18 may be connected to the main body 12 in order to supply external current to the head-mounted display apparatus 10 for implementing virtual reality. The head-mounted display apparatus 10 for implementing virtual reality according to the embodiment may be light, since a power source is provided outside the head-mounted display apparatus. Each of the first cable 16 and the second cable 18 may be, for example, a universal serial bus (USB) cable.

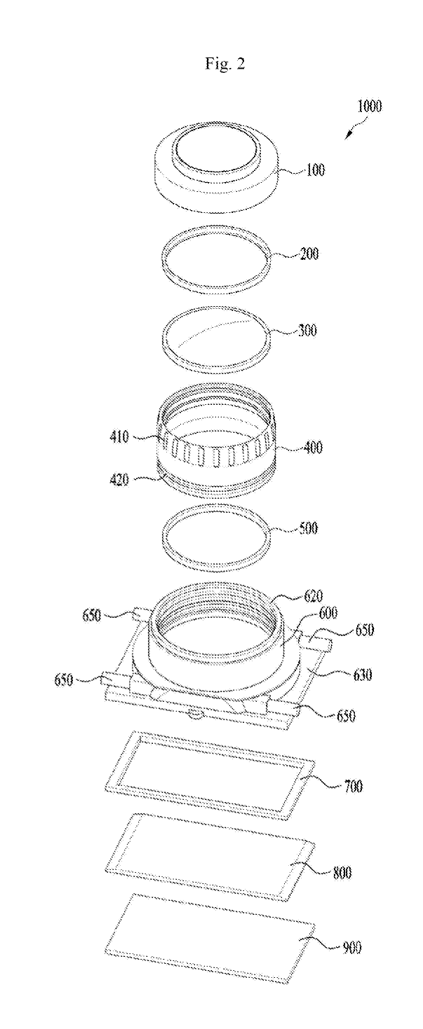

FIG. 2 is an exploded perspective view showing the optical device of FIG. 1.

The optical device 1000 according to the embodiment may include a lens cover 100, a fixing ring 200, a lens 300, a lens-moving unit 400, a stopper 500, a holder 600, a fixing unit 700, a display unit 800, and a protection unit 900.

The lens 300 will be described in detail with reference to FIG. 4. At least one lens 200 may be provided. In the embodiment shown, at least a portion of one lens 300 may be inserted into and fixed in the lens-moving unit 400. A plurality of lenses 300 may be provided to constitute a lens unit. In addition, the lens 300 may be a Fresnel lens, which has an irregular part formed on at least one surface thereof.

The fixing ring 200 may be disposed at the edge of the lens 300 that is inserted into the lens-moving unit 400. The fixing ring 200 may be inserted between the edge of the lens 300 and the lens-moving unit 400 to prevent the lens 300 from being separated from the lens-moving unit 400.

The lens cover 100, which is disposed in front of the lens 300, may prevent foreign matter from being attached to the surface of the lens 300 or may prevent the lens 300 from being scratched. When the head-mounted display apparatus 10 for implementing virtual reality is used, the lens cover 100 may be separated from the optical device 1000.

A plurality of patterns 410 may be disposed on the outer circumferential surface of the lens-moving unit 400. The patterns 410 may be embossed on the surface of the lens-moving unit 400, or may be engraved in the surface of the lens-moving unit 400. The patterns 410 may be used when the user rotates the lens-moving unit 400 so as to be adjacent to the holder 600 or to be distant from the holder 600. Consequently, an image, which is generated by the display unit 800 and is transmitted through the lens 300, may be accurately focused on the eye of the user.

The patterns 410 may be provided at the upper part of the outer circumferential surface of the lens-moving unit 400. A first screw thread 420 may be provided at the lower part of the outer circumferential surface of the lens-moving unit 400 so as to protrude outward.

The holder 600 may be a housing of the optical device 1000. At least a portion of the holder 600 may be formed in the shape of a body tube. A second screw thread 620 may be provided in the upper part of the inner circumferential surface of the holder 600 so as to be recessed inward. The second screw thread 620 may be reverse to the first screw thread 420. When the lens-moving unit 400 is rotated in a first direction, therefore, the lens-moving unit 400 may be gradually inserted into the holder 600, whereby the lens 300 may approach the display unit 800, a description of which will follow. When the lens-moving unit 400 is rotated in a second direction, the lens-moving unit 400 may be gradually separated from the holder 600, whereby the lens 300 may become distant from the display unit 800.

The stopper 500 may be disposed between the edge of the holder 600 and the edge of the lens-moving unit 400. The diameter of the inner circumferential surface of the stopper 500 may be smaller than the diameter of the outer circumferential surface of the first screw thread 420, which is provided at the outer circumferential surface of the lens-moving unit 400, in order to prevent the lens-moving unit 400 from being separated from the holder 600 even when the lens-moving unit 400 is continuously rotated in the second direction.

The lower surface of the holder 600 may be formed in the shape of a support plate 630, by which the holder 600 may be easily coupled to the display unit 800. The support plate may be a location part, on which the display unit 800 is disposed. The support plate 630 may be disposed so as to be perpendicular to an optical axis of the lens 300. The support plate 630 may be formed in the shape of a rectangle having a horizontal length greater than a vertical length. The shape of the support plate 630 may be changed depending on the shape of the display unit 800 or the fixing unit 700.

A pair of sliding bars 650 may be provided inside the support plate 630 of the holder 600. The sliding bars 650 may protrude to opposite sides of the support plate 630. The sliding bars 650 may be inserted through through-holes (not shown) formed in the support plate 630. The sliding bars 650 may be moved relative to the sliding bars 650 to change the position of the lens unit 1000. It is possible to adjust the distance between the lens units 1000 based on the distance between the eyes of the user by changing the position of the lens unit 1000 using the sliding bars 650.

The display unit 800 may be disposed under the holder 600. The display unit 800 may display a motion image or a still image. The display unit 800 may be, for example, a liquid crystal display (LCD) or a display panel. One display unit 800 may be provided, or a pair of display units 800 may be provided, as will be described below, in order to transmit images to the left and right eyes of the user.

The display unit 800 may be fixed to the lower part of the holder 600 via the fixing unit 700. The fixing unit 700 may be, for example, a double-sided tape.

The fixing unit 700 may fix the lower part of a second region of the fixing holder 600 and the edge of the display unit 800 in a sealed state. Consequently, the fixing unit 700 may prevent external light from being introduced into the optical device 1000.

The fixing unit 700 may be open in the middle region thereof such that an image from the display unit 800 can be transmitted to the lens 300. In addition, the lower part of the holder 600 may be open in the middle region thereof such that an image from the display unit 800 can be transmitted to the lens 300.

The display unit 800 may include a light source. The light source may be, for example, a light-emitting diode.

The protection unit 900 may be provided under the display unit 800 in order to support the display unit 800 and to fix a printed circuit board (PCB) or a flexible PCB (FPCB) (not shown) of the display unit 800.

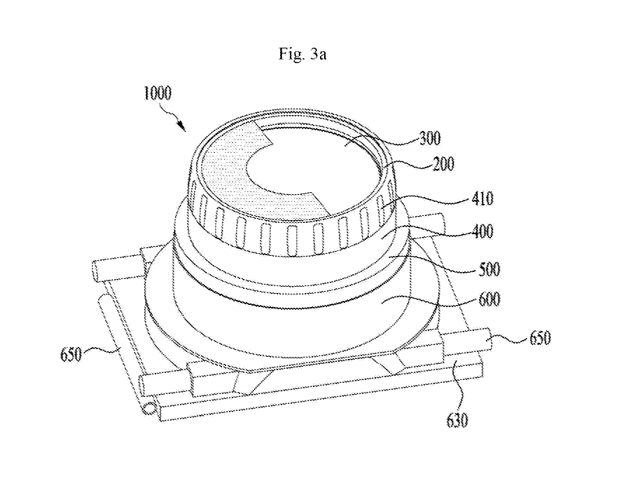

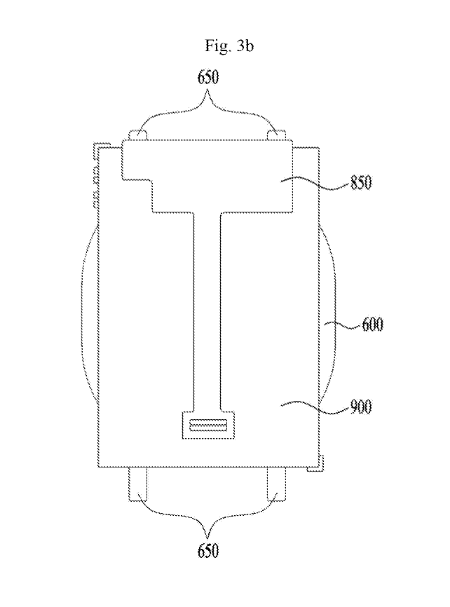

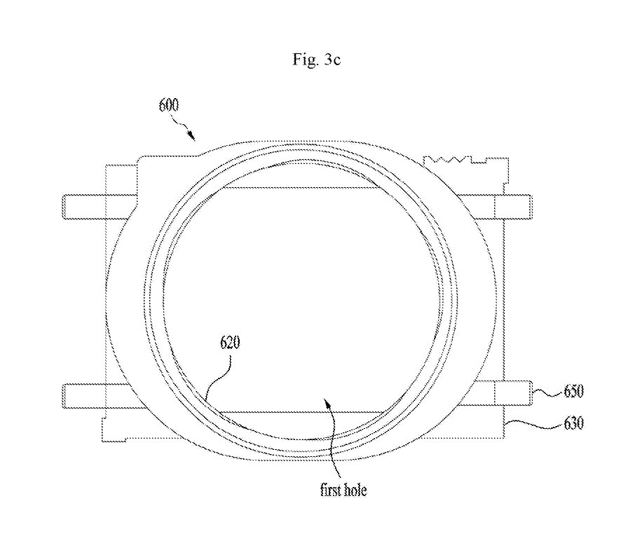

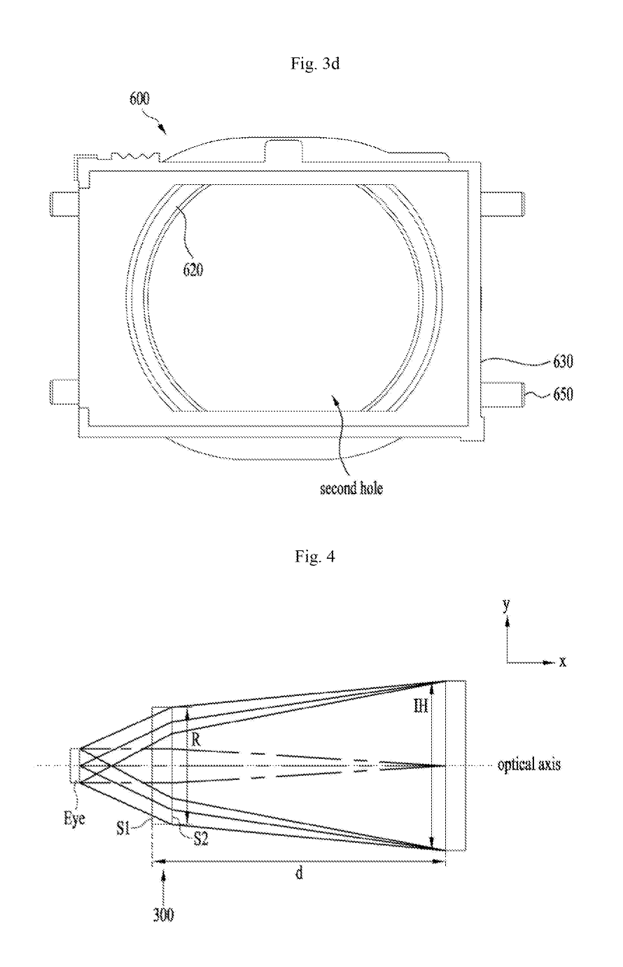

FIGS. 3a and 3b are, respectively, a perspective view and a rear view showing the optical device of FIG. 1.

Referring to FIG. 3a, the holder 600 may include a support plate 630 and sliding bars 650, which are exposed from opposite sides of the support plate. The lens-moving unit 400 may be inserted into the holder 600. The stopper 500 may be disposed at the edge of the coupling region between the lens-moving unit 400 and the holder 600. A plurality of patterns 410 may be provided at the outer circumferential surface of the lens-moving unit 400. The fixing ring 200 may be disposed at the edge of the lens 300 inserted into the lens-moving unit 400.

Although not shown, the display unit 800 may be fixed to the lower surface of the holder 600 via the fixing member 700. A circuit board 850 may be bent at the edge of the protection unit 900 (not shown) under the display unit 800. The circuit board 850 may be, for example, an FPCB.

Since the head-mounted display apparatus 10 for implementing virtual reality includes a pair of optical devices 1000, at least one pair of lenses 300 and a pair of display units 800 may be provided. In another embodiment, at least one pair of lenses 300 and a display unit 800 may be provided. On the assumption that a pair of lenses 300 includes a first lens and a second lens and a pair of display units 800 includes a first display unit and a second display unit, an image from the first display unit may be output through the first lens, and an image from the second display unit may be output through the second lens.

FIGS. 3c and 3d are views respectively showing openings in a first region and a second region of the fixing holder.

The region of the fixing holder 600 at which a lens unit including a lens is disposed may be referred to as a first region. The lens unit may include at least one lens and a lens-moving unit 400 having the lens disposed in the space defined therein. A hollow opening may be formed in the first region of the fixing holder 600. The opening formed in the first region may be a circular opening. The region of the fixing holder that faces the display unit may be referred to as a second region. A hollow opening may also be formed in the second region of the fixing holder 600. The second region may be rectangular.

As described above, the display unit may be formed in the shape of a rectangle. Consequently, an image from the display unit may be incident on the lens in the state in which a portion of the effective region of the image is blocked by the display unit. Specifically, when an image output from the display unit passes through the opening in the second region of the fixing holder 600, four parts of the rectangular effective region of the image, including the apexes of the image, may be covered or blocked. The reason for this is that the shape of the hollow opening in the second region may be different from the shape of the display unit.

As shown, the opening in the second region may have two flat surfaces that face each other and two curved surfaces that face each other.

FIG. 4 is a detailed view showing the lens and the display unit of FIG. 1.

An embodiment of the lens 300 includes a first surface S1 and a second surface S2, which face each other. The first surface S1 is the surface of the lens 300 that faces the eye of an observer, i.e. a user who wears the head-mounted display apparatus 1000 for implementing virtual reality, and the second surface S2 is the surface of the lens 300 that faces the display unit 800. The lens 300 and the display unit 800 may constitute an optical device.

The lens 300 may be made of plastic. However, the disclosure is not limited thereto.

As shown, the eye and the lens 300 may be disposed so as to be spaced apart from each other, and the distance therebetween may not be fixed, but may vary. The lens 300 and the display unit 800 may be disposed so as to be spaced apart from each other, and the distance therebetween may not be fixed, but may vary. This function may be realized as the first and second screw threads 420 and 620 of the lens-moving unit 400 and the holder 600 are rotated in the first direction or the second direction in the state of being engaged with each other, as described above.

The first surface S1 and the second surface S2 may be surfaces having a pitch diameter, through which an image from the display unit passes.

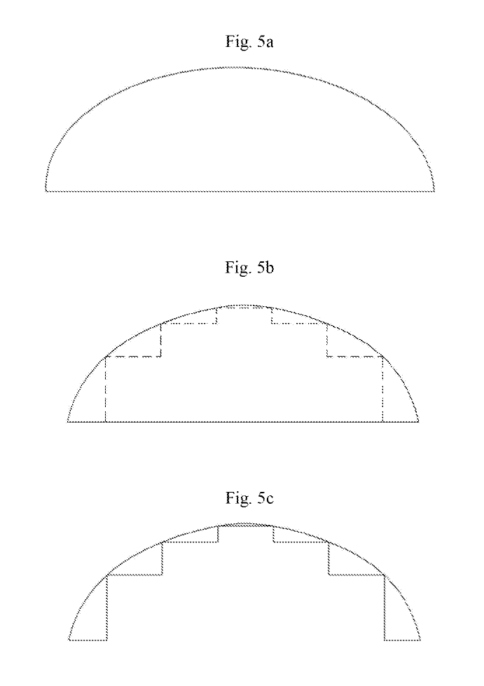

At least one of the first surface S1 or the second surface S2 may have a non-uniform height and may be disposed so as to have a height deviation. In particular, the first surface S1 may be flat, and the second surface S2 may be disposed so as to have a height deviation. The shape of the second surface S2 will be described in detail with reference to FIGS. 5a to 5d.

The surface of the lens 300 within the pitch diameter of the first surface S1 and the second surface S2 of the lens 300 may have no point of inflection. A point of inflection may be formed at the remaining region of the lens excluding the pitch diameter thereof. Here, the pitch diameter may be the range of a path along which light passes when an image emitted from the display unit 800 advances to the eye.

In FIG. 4, on the assumption that the optical axis direction of the lens is an x-axis direction and the direction that is perpendicular to the optical axis direction is a y-axis direction, the distance d from the first surface S1 of the lens 300 to the display unit 800 in the optical axis direction may be greater than the size (image height) (IH) of the display unit 800 in the y-axis direction. Here, the optical axis may be referred to as a first axis. The first surface S1 of the lens 300 may be perpendicular to the first axis.

The size R of the lens 300 may be equal to or less than the size (IH) of the display unit 800. Here, the size R of the lens 300 indicates the diameter of the lens when the section of the lens in the y-axis direction is circular, and the size R of the lens 300 indicates the length of the long side of the lens when the section of the lens in the y-axis direction is rectangular. The size of the display unit 800 indicates the length of one side of the display unit when the region of the display unit 800 from which an image is output is square, and the size of the display unit 800 indicates the length of a long side of the display unit when the region of the display unit 800 from which an image is output is rectangular.

A pair of lenses 300 may be provided. Consequently, an image output from the display unit 800 may be focused on different positions, such as the left eye and the right eye, through the respective lenses 300.

FIGS. 5a to 5d are views showing the principle of the lens. The process of manufacturing the lens is not shown. The lens may be manufactured using a mold having a shape that is reverse to the shape of the lens shown in FIG. 5d.

A Fresnel lens is shown in FIG. 5a. In FIGS. 5b and 5c, the Fresnel lens is partitioned into sections having the same width in the leftward-rightward direction. Each part of the lens that protrudes in the direction that is parallel to the optical axis may be referred to as an optical path conversion unit. In this embodiment, the optical path conversion unit may be circular.

Seven optical path conversion units U0 to U23 are shown in FIG. 5d. In actuality, a larger number of optical path conversion units U0 to U23 may be disposed.

An 11th optical path conversion unit U11 to a 13th optical path conversion unit U13 are disposed from the optical path conversion unit U0, which is disposed at the central part of the lens, in the leftward direction, and a 21st optical path conversion unit U21 to a 23rd optical path conversion unit U23 are disposed from the optical path conversion unit U0 in the rightward direction. The optical path conversion units, which are disposed so as to be symmetrical with respect to the center of the lens, may be connected in a circular shape to constitute a circular optical path conversion unit.

The widths d0 to d23 of the optical path conversion units U0 to U23 may be uniform, and the heights h0 to h23 of the optical path conversion units U0 to U23 may be different from each other. Here, the heights h0 to h23 may be the maximum heights of the optical path conversion units U0 to U23.

Each optical path conversion unit may be provided with a ridge formed in the direction that is parallel to the optical axis, and a valley may be provided between each pair of adjacent optical path conversion units. Each ridge and each valley may become criteria based on which the height and the width of each optical path conversion unit are measured. For example, the distance between one ridge and another ridge in the direction that is perpendicular to the optical axis or the distance between one valley and another valley in the direction that is perpendicular to the optical axis may be the width of each optical path conversion unit, and the distance between one ridge and one valley in the direction that is parallel to the optical axis may be the height of each optical path conversion unit.

Specifically, the height of the optical path conversion unit disposed at the central part of the lens in the direction that is parallel to the optical axis may be smaller than the height of the optical path conversion unit disposed at the peripheral part of the lens in the direction that is parallel to the optical axis. Consequently, the height h0 of the optical path conversion unit U0, which is disposed at the central part of the lens, may be the smallest, the heights h13 and h23 of the optical path conversion units U13 and U23, which are disposed at the peripheral part of the lens, may be the largest, and the heights h12 and h22 of the optical path conversion units U12 and U22, which are disposed on the left side and the right side of the optical path conversion unit U0, respectively, may be the same as each other. In the figure, one of the optical path conversion units is formed at the central part of the lens. However, the disclosure is not limited thereto. No optical path conversion unit may be formed at the central part of the lens, and the central part of the lens may be flat.

Specifically, the widths d0 to d23 of the optical path conversion units U0 to U23 may be 10 μm to 1 mm, and the heights h0 to h23 of the optical path conversion units U0 to U23 may be 0.5 mm or less, at least 0.1 mm. In addition, the width of each optical path conversion unit may be the distance between the respective ridges in the horizontal direction (the direction that is perpendicular to the optical axis), or the width of each optical path conversion unit may be the distance between the respective valleys in the horizontal direction.

The distance between the ridges of the respective optical path conversion units may be 10 μm to 1 mm, and the height of each optical path conversion unit may be 0.5 mm or less.

The upper parts of the optical path conversion units U0 to U23 may be formed on the second surface S2 of the lens 300, and the lower parts of the optical path conversion units U0 to U23 may correspond to the first surface S1 of the lens 300. In addition, the center of the optical path conversion unit shown in FIG. 5d may not coincide with the geometrical center of the second surface S2 of the lens 300. That is, the geometrical center of the second surface and the center of the optical path conversion unit on the first surface may be formed at different positions.

Since the optical path conversion units U0 to U23 may be formed in a point-symmetrical shape having the same center, the optical path conversion units UI 1 and U21 may be connected to each other, the optical path conversion units U12 and U22 may be connected to each other, and the optical path conversion units U13 and U23 may be connected to each other.

In FIGS. 5a to 5d, there is shown the principle by which the lens 300 in the optical device according to this embodiment is configured based on a convex lens. Alternatively, the lens 300 in the optical device according to this embodiment may be configured based on a concave lens or a lens having any one of the other different shapes.

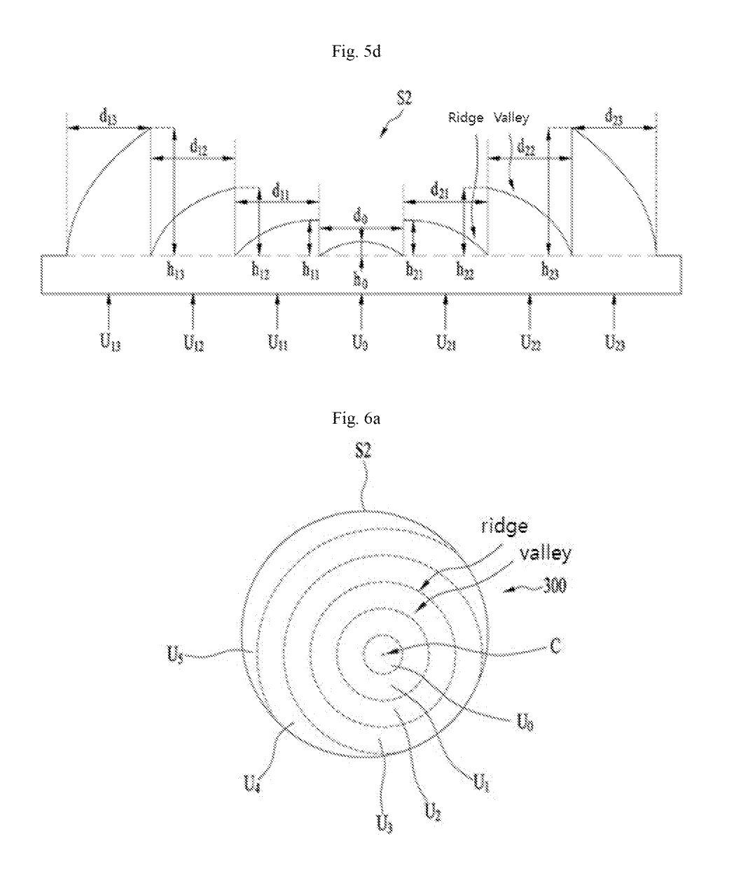

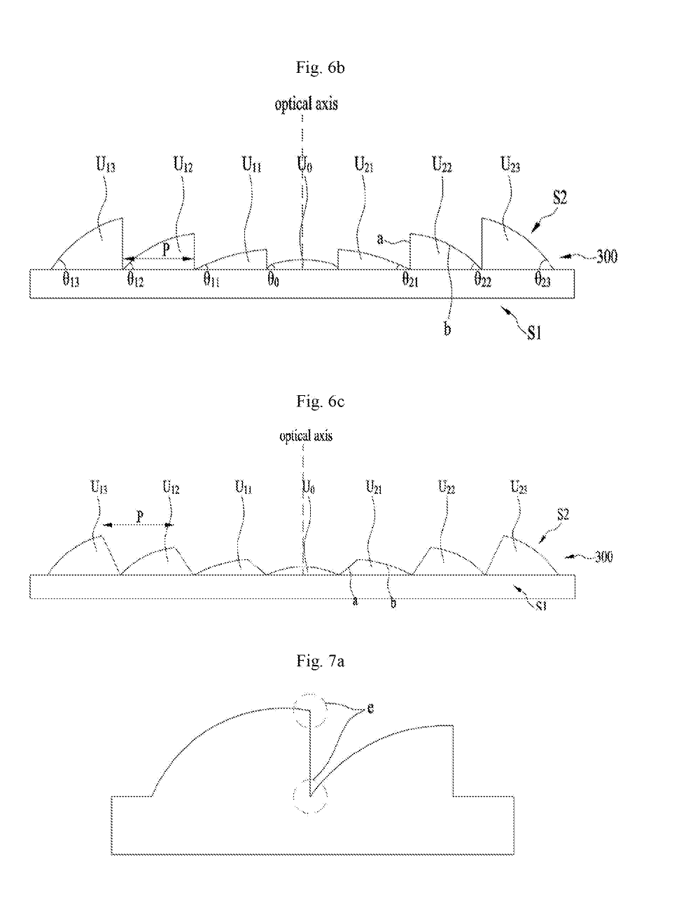

FIGS. 6a to 6c are detailed views showing the second surface of the lens.

Each optical path conversion unit may include a first part and a second part having different inclinations with respect to the first axis, which is perpendicular to the first surface S1. The height of the optical path conversion unit disposed at the central part of the second surface in the first-axis direction and the height of the optical path conversion unit disposed at the peripheral part of the second surface in the first-axis direction may be different from each other, which will be described below in detail.

FIGS. 6b and 6c are sectional views of the second surface S2 of the lens 300 of FIG. 4, taken in the y-axis direction. Specifically, FIGS. 6b and 6c are sectional views taken along the center of the second surface S2.

A plurality of optical path conversion units U0 to U5 may be disposed on the second surface S2 of the lens 300. The center C of the optical path conversion units U0 to U5 may be spaced apart from the geometrical center of the second surface S2. Here, the geometrical center of the second surface S2 may be the center of a pitch diameter.

Each of the optical path conversion units U0 to U23 may include a first part a and a second part b. The first part a and the second part b may be surfaces that constitute the second surface S2. In FIGS. 6b and 6c, the bottom surfaces of the optical path conversion units U0 to U23 may constitute the first surface S1.

In FIG. 6b, the first part a of each of the optical path conversion units U0 to U23 may be parallel to the optical axis. In consideration of manufacturing error, however, the first part may not be parallel to the optical axis. The second part b of each of the optical path conversion units U0 to U23 may be a flat surface that is inclined with respect to the optical axis and has no curvature, may have a straight-line structure having no curvature, or may have a curvature. Since the optical path conversion units are manufactured according to the principle of FIGS. 5a to 5d, the curvatures of the second parts b may be equal to each other. In consideration of manufacturing error, however, the curvatures of the second parts b may not be equal to each other. In addition, the curvatures of the second parts b may be different from each other, and each of the second parts b may be a straight line or a flat surface having no curvature.

In FIG. 6b, the angles θ0 to θ23 of the optical path conversion units U0 to U23 with respect to the horizontal plane are shown. The angle θ0 of the optical path conversion unit U0, which is provided at the central part of the lens, with respect to the horizontal plane may approximate 0 degrees, and the angle of the optical path conversion unit may gradually increase toward the peripheral part of the lens. Consequently, the angle θ23 of the optical path conversion unit U23, which is provided at the peripheral part of the lens, with respect to the horizontal plane may be the largest.

In addition, the pitch P between the highest points of the optical path conversion units U0 to U23 may be uniform.

The embodiment of FIG. 6c is identical to the embodiment of FIG. 6b except that the first part a may not be parallel to the optical axis but may be inclined with respect to the optical axis and that the section of the first part a may be a straight line, unlike the second part b.

In FIG. 6c, the pitch P between the highest points of the optical path conversion units U0 to U23 may be uniform.

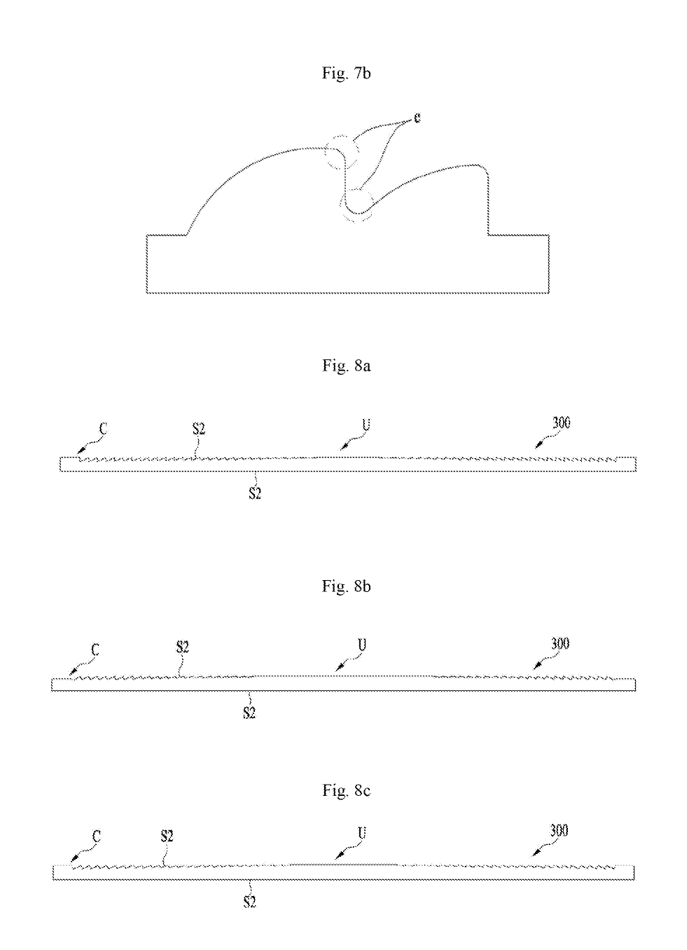

FIGS. 7a and 7b are views showing the shape of edge regions of the lens.

Here, the edge regions are regions denoted by e. As shown in FIG. 7a, each of the edge regions may be formed in a shape having discontinuous curvature. Alternatively, as shown in FIG. 7b, each of the edge regions may be formed in a round shape. The edge regions may be rounded depending on the design of the lens or the injection-molding characteristics of the mold.

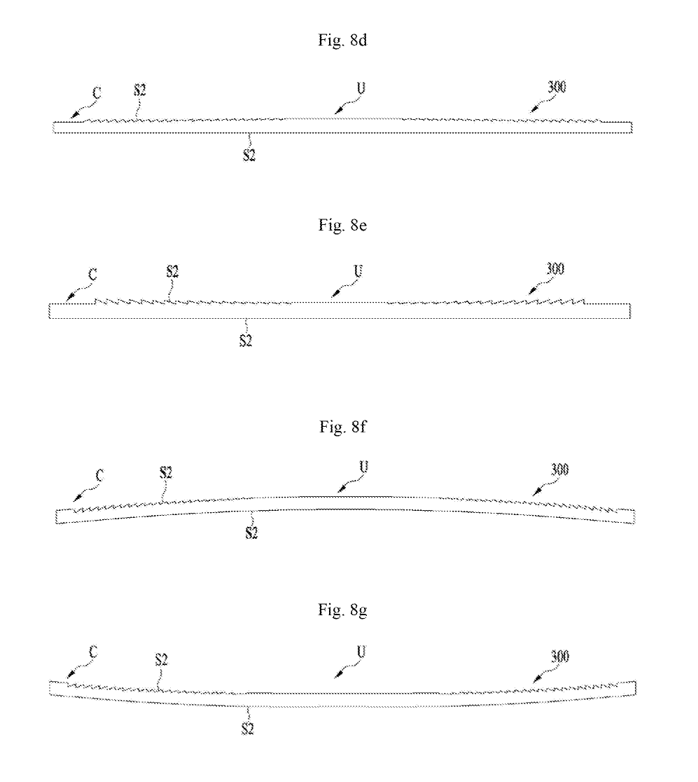

FIGS. 8a to 8g are views showing other embodiments of the lens.

The lower surface of the lens 300 is a first surface S1, and the upper surface of the lens 300 is a second surface S2. A connection part C is formed at the edge of the lens. The connection part C may be a part of the lens that is fixed to the lens-moving unit 400 or the fixing holder. The width, the thickness, or the shape of the connection part C may be changed depending on the structure by which the lens is coupled to the lens-moving unit 400.

In FIG. 8a, a larger number of optical path conversion units U than the number of optical path conversion units of the lens shown in FIG. 6c are shown. In actuality, optical path conversion units may be formed on a lens having a pitch diameter of about 40 mm at a pitch of about 0.2 μm. In FIG. 8a, therefore, about 200,000 optical path conversion units U may be provided on a lens having a pitch diameter of about 40 mm. In consideration of a concentric circle structure, about 100,000 optical path conversion units U may be provided.

The lens 300 according to the embodiment shown in FIG. 8b is characterized in that the optical path conversion units U are rounded, as shown in FIG. 7b. In the embodiment shown in FIG. 8a, the optical path conversion units U are provided from the connection part C so as to be recessed. In the lens 300 according to the embodiment shown in FIG. 8b, however, the optical path conversion units U are formed from the connection part C so as to protrude.

The lenses 300 according to the embodiments shown in FIGS. 8c and 8d are different from the lenses according to the embodiments shown in FIGS. 8a and 8b, in which one side surface of each optical path conversion unit U is vertical, in that the opposite side surfaces of each optical path conversion unit U are inclined.

In the embodiment shown in FIG. 8e, the inclination direction of each optical path conversion unit U is the opposite of the inclination directions of the optical path conversion units U shown in FIGS. 8a to 8d.

In the embodiments shown in FIGS. 8f and 8g, the optical path conversion units U are similar to the optical path conversion units according to the embodiment shown in FIG. 8a. Specifically, the lens 300 may be generally convex or concave.

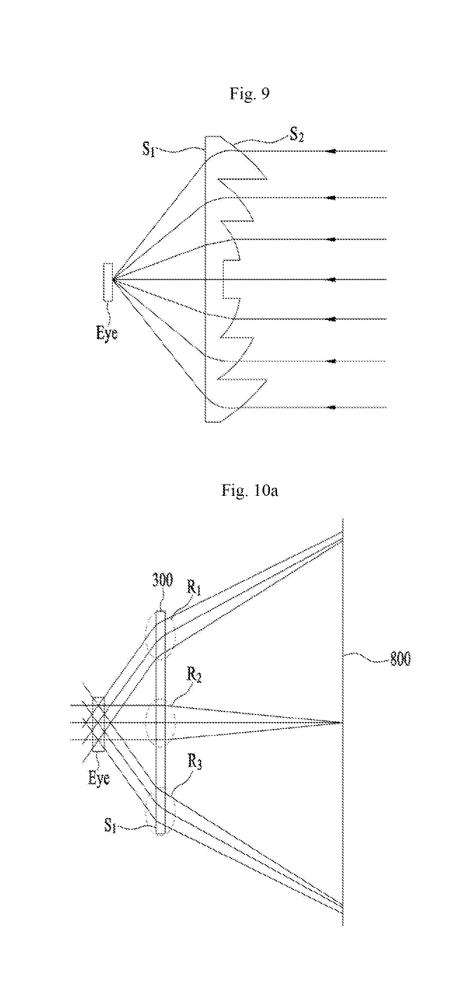

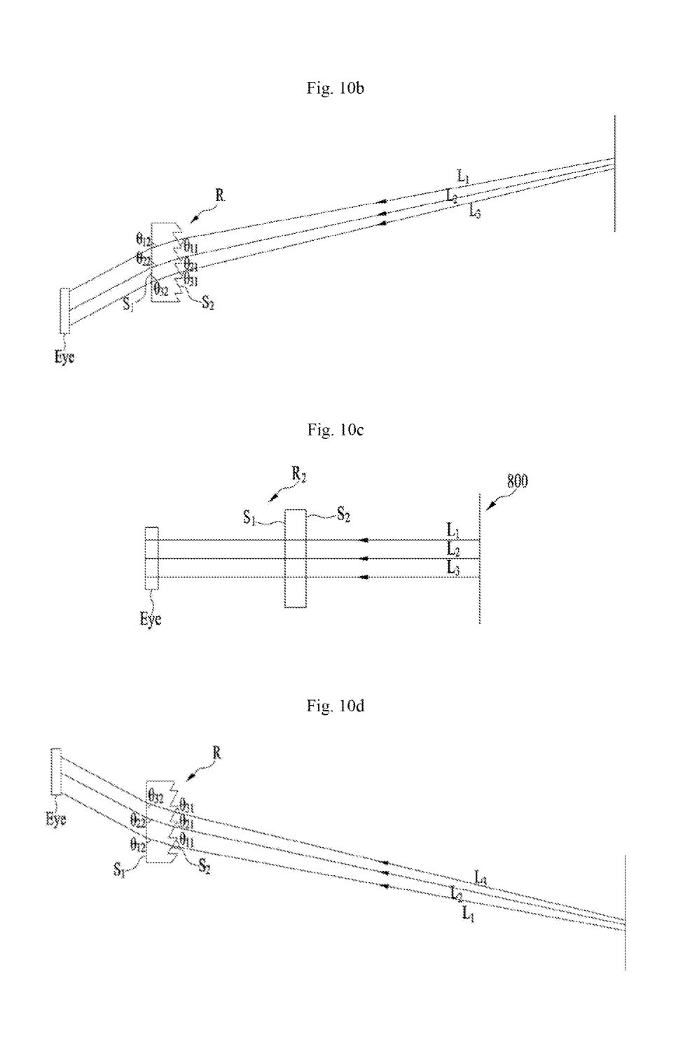

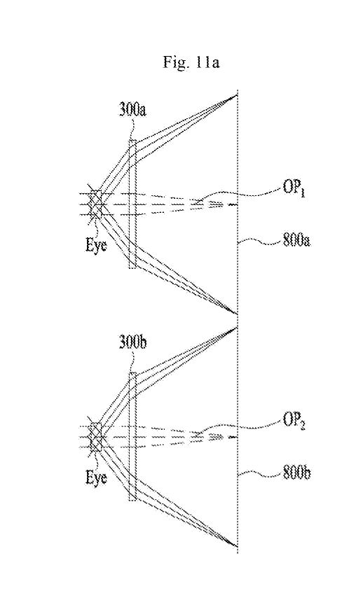

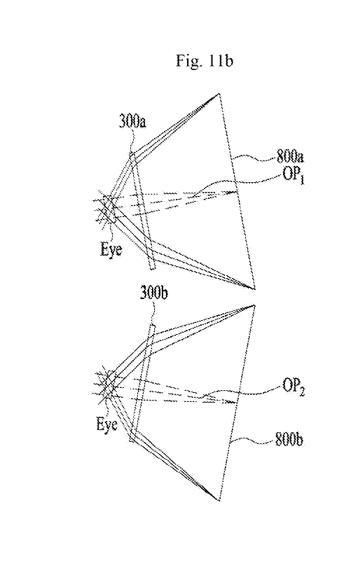

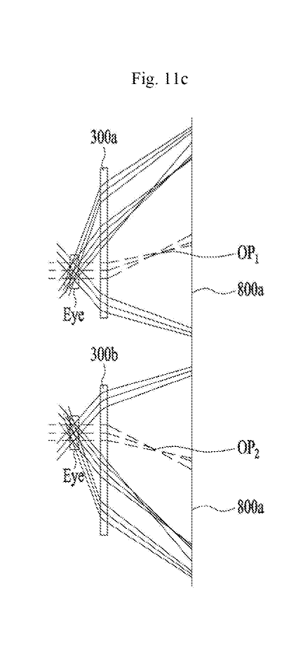

FIG. 9 is a view showing the principle by which beams passing through the lens converge, and FIGS. 10a to 10d are views showing the principle by which beams converge at each region of the lens.

Referring to FIG. 9, beams may be incident on the second surface S2 of the lens 300 from the front of the lens 300, and may converge toward the eye of the user through the first surface S1.

In FIG. 10a, beams emitted from the display unit 800 converge to the eye of the user through first and third region R1 and R2 of the lens 300, which are provided at the edge of the lens 300, and a second region R2, which is provided at the center of the lens 300. The optical paths at the first to third regions R1 to R3 of the lens are shown in detail in FIGS. 10b to 10d.

In FIG. 10h, beams L1 to L3 may be emitted from a point of the display unit, may pass through the first region R1 of the lens, and may advance to the eye while being parallel to each other. Here, the angle of the beams with respect to the first surface S1 and the second surface S2 of the optical path conversion units at the first region R1 of the lens may be θ11>θ21>θ31 and θ12>θ22>θ32. The angle of the beams may increase as the beams become distant from the optical axis.

Beams advancing to the eye from the second surface R1 of the lens may be parallel to each other.

In FIG. 10c, the second surface S2 of the second region R2 of the lens is almost flat, and beams L1 to L3 emitted from the display unit 800 advance to the eye through the second region R2 of the lens.

In FIG. 10d, beams L1 to L3 may be emitted from a point of the display unit, may pass through the third region R3 of the lens, and may advance to the eye while being parallel to each other. Here, the angle of the beams with respect to the first surface S1 and the second surface S2 of the optical path conversion units at the first region R1 of the lens may be the same as the angle of the beams shown in FIG. 10b.

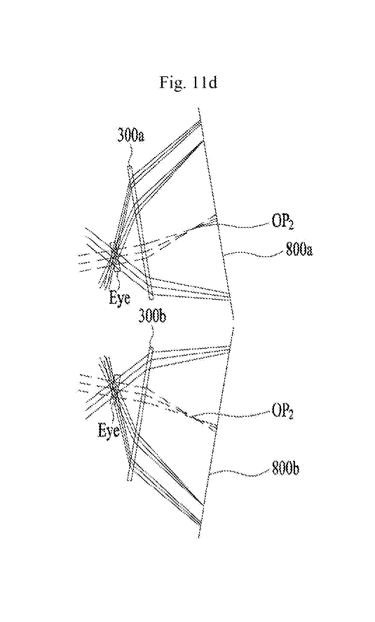

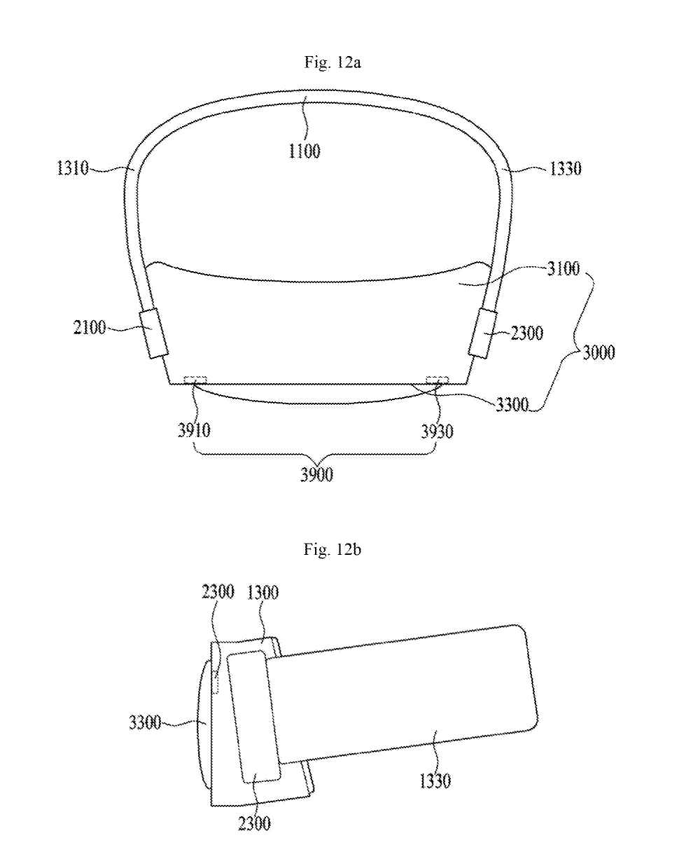

FIGS. 11a to 11 d are detailed views showing the arrangement of a pair of lenses and display units.

In the embodiment of FIG. 11a, a pair of lenses 300a and 300b and a pair of display units 800a and 800b are disposed. Each of the lenses 300a and 300b and each of the display units 800a and 800b may be identical to the lens and display unit according to the embodiments described above.

The optical axis OP1 of one lens 300a may be parallel to the optical axis OP2 of the other lens 300b. In addition, light emitted from the display units 800a and 800b may pass through the lenses 300a and 300b, and may be focused on the eyes (the left eye and the right eye).

In FIGS. 11a to 11d, the display units 800a and 800b may be disposed so as to be perpendicular to the optical axes OP1 and OP2.

The embodiment of FIG. 11b is identical to the embodiment of FIG. 11a except that the optical axis OP1 of one lens 300a may not be parallel to the optical axis OP2 of the other lens 300b. In addition, the display units 800a and 800b may be disposed so as to be inclined with respect to each other. Light emitted from the display units 800a and 800b may pass through the lenses 300a and 300b, and may be focused on the eyes (the left eye and the right eye).

The inclination angle of each optical axis may be 60 degrees or less. In the case in which the lens 300a and 300b and the display units 800a and 800b are disposed, as shown in FIG. 11b, it is possible to increase the size of the display units 800a and 800b, whereby it is possible to increase the angle of view without increasing the volume of the optical device.

The embodiment of FIG. 11c is identical to the embodiment of FIG. 11a except that the optical axes OP1 and OP2 of the lens 300a and 300b are spaced apart from the geometrical centers of the lens 300a and 300b.

The embodiment of FIG. 11d is identical to the embodiment of FIG. 11c except that the optical axis OP1 of one lens 300a may not be parallel to the optical axis OP2 of the other lens 300b. In addition, the display units 800a and 800b may be disposed so as to be inclined with respect to each other. Light emitted from the display units 800a and 800b may pass through the lenses 300a and 300b, and may be focused on the eyes (the left eye and the right eye).

The inclination angle of each optical axis may be 60 degrees or less.

In FIGS. 11b and 11d, the optical axes OP1 and OP2 may be spaced apart from the centers of the lens 300a and 300b in opposite directions. Specifically, the optical axis OP1 may be spaced apart from the center of the lens 300a in an upward direction, and the optical axis OP2 may be spaced apart from the center of the lens 300b in a downward direction.

When the optical axes OP1 and OP2 are spaced apart from the centers of the second surfaces S2 of the lens 300a and 300b by about 1 mm, the angle of view may be increased by about 1 degree. The optical axes OP1 and OP2 may be spaced apart from the centers of the second surfaces S2 of the lens 300a and 300b by up to 10 mm. In this case, the angle of view of the optical device may increase by about 20 degrees.

The thickness of each of the lens 300a and 300b may be reduced so as to be smaller than the thickness of a conventional lens, whereby the volume and weight of the optical device may be reduced. Particularly, in FIG. 4, the distance d between the first surface S1 of the lens 300 and the display unit 800 may be reduced.

Also, in FIGS. 11b and 11d, when the optical axes OP1 and OP2 are inclined upward and downward with respect to the horizontal direction by 1 degree, the angle of view of the optical device may increase by about 1 degree.

In the lenses 300a and 300b, therefore, the optical axes OP1 and OP2 are inclined with respect to the horizontal direction, whereby the angle of view increases by about 20 degrees, and the optical axes OP1 are inclined with respect to each other in opposite directions, whereby the angle of view increases by about 60 degrees. Consequently, it is possible to increase the angle of view of the optical device to about 170 degrees, which is greater than the angle of view of a conventional optical device, which is about 90 degrees.

A head-mounted display apparatus for implementing virtual reality including the optical device may receive a signal related to an image to be displayed on an external device, such as a smartphone, a laptop computer, or a smart TV. Consequently, a user may wear the head-mounted display apparatus to view a 3D or 2D image.

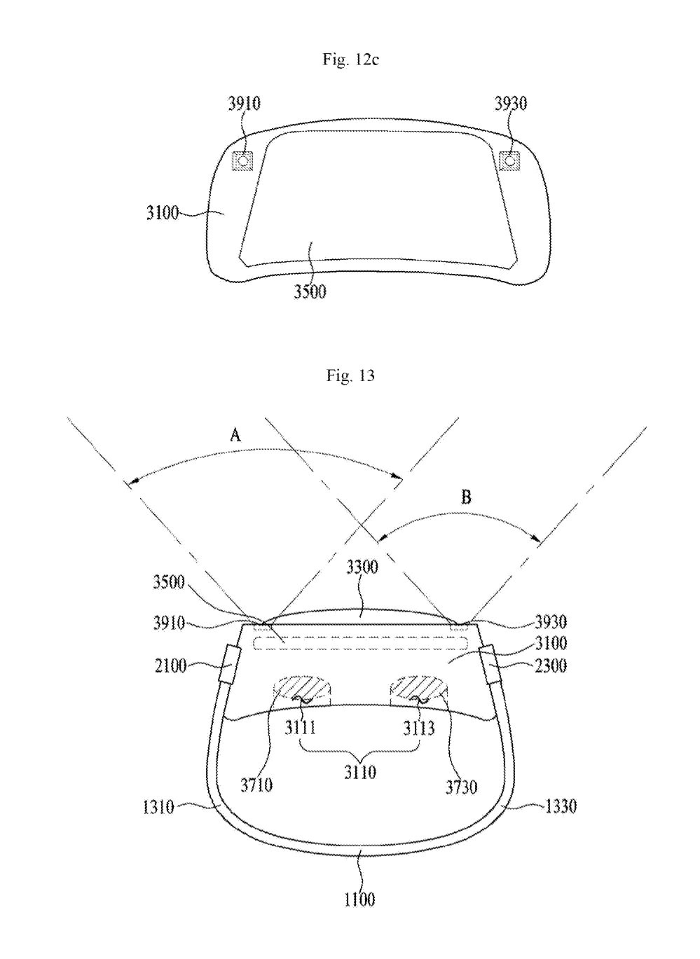

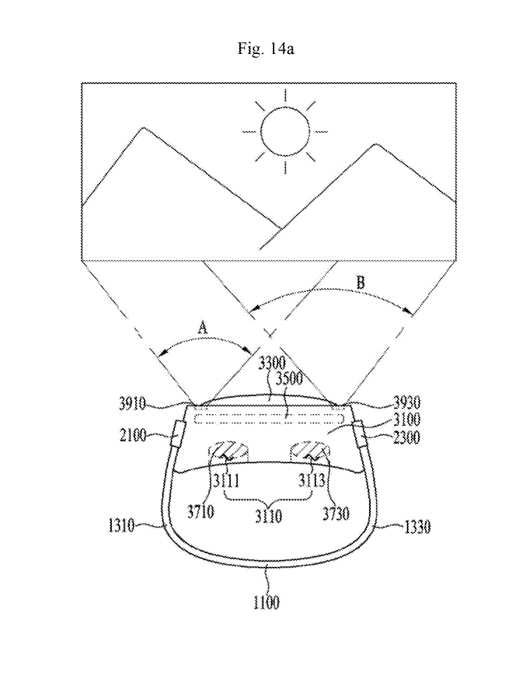

FIGS. 12a to 12c are perspective views schematically showing another embodiment of the head-mounted display apparatus for implementing virtual reality, and FIG. 13 is a detailed view showing the head-mounted display apparatus for implementing virtual reality of FIGS. 12a to 12c.

Referring to FIGS. 12a to 12c, the head-mounted display apparatus for implementing virtual reality according to this embodiment may include a holding unit 1100 and 1300 for providing a space in which the head of a user is held, a display unit 300 for displaying a scene to be viewed by the user and information added by the head-mounted display apparatus, and a coupling unit 2100 and 2300 for coupling the holding unit 1100 and 1300 and the display unit 3000.

The holding unit 1100 and 1300 may include a flat unit 1100, configured to support the rear of the head of the user, and a curved unit 1300, configured to support opposite sides of the head of the user.

The curved unit 1300 may include a first curved part 1310 configured to support the right side of the head of the user and a second curved part 1330 configured to support the left side of the head of the user.

Since the user who wears the head-mounted display apparatus for implementing virtual reality according to this embodiment directly contacts the holding unit 1100 and 1300, the holding unit 1100 and 1300 may be made of a material that is capable of giving the user comfort when the user wears the head-mounted display apparatus for implementing virtual reality according to the embodiment.

In addition, since the curved unit 1300 is configured to support the opposite sides of the head of the user, the curved unit 1300 may be configured such that the curvature of the curved unit 1300 is variable.

Consequently, the first curved part 1310 and the second curved part 1330 may have the same curvature. As needed, the first curved part 1310 and the second curved part 1330 may have different curvatures.

In addition, the holding unit 1100 and 1300 may be formed in the shape of a band that is used in general goggles.

In this case, the holding unit 1100 and 1300 may be made of an elastic material.

The opposite ends of the holding unit 1100 and 1300 may be provided between the coupling unit 2100 and 2300 and one surface of the display unit 3000.

In addition, the coupling unit 2100 and 2300 may protrude from the outer circumferential surface of the display unit 3000, and the holding unit 1100 and 1300 may be inserted into recesses formed in the coupling unit 2100 and 2300.

However, it is sufficient for the coupling unit 2100 and 2300 to couple the holding unit 1100 and 1300 and the display unit 3000. The shape of coupling between the coupling unit 2100 and 2300 and the display unit 3000 may be modified as needed, and is not limited to the embodiment shown in the drawings.

The display unit 3000 may include a body 3100, which defines the external appearance thereof, an outer cover 3300 provided in front of the body 3100, a panel 3500 for displaying a scene to be viewed by the user and information added by the head-mounted display apparatus, a lens unit 3700 for enabling the user to view an image displayed on the panel 3500 as a virtual image, and a camera unit 3900 provided at the front of the body 3100 for photographing an external image.

The body 3100 may be made of a material that is capable of supporting the head-mounted display apparatus for implementing virtual reality according to the embodiment.

For example, the body 3100 may be made of a rigid material that is capable of protecting the head-mounted display apparatus for implementing virtual reality from external impacts.

In addition, the body 3100 may be made of a lightweight material in consideration of user convenience.

For example, the body may be made of various materials, such as a composite material, plastic, iron.

The body 3100 may be provided at the inside thereof, i.e. at the part thereof that contacts the two eyes of the user, with a concave unit 3110, which is concave in the inward direction of the body 3100.

Since the user has two eyes, the concave unit may include a first concave part 3111 corresponding to the left eye of the user and a second concave part 3113 corresponding to the right eye of the user.

In the head-mounted display apparatus for implementing virtual reality according to the embodiment, the lens unit 3700 may be located at the point at which the concave unit 3110 and the body 3100 meet each other.

The lens unit 3700 may include a first lens 3710, provided at the point at which the first concave part 3111 and the body 3100 meet each other, and a second lens 3730, provided at the point at which the second concave part 3113 and the body 3100 meet each other.

A fisheye lens may be used as the lens unit 3700.

The fisheye lens is a specific kind of super-wide-angle retrofocus lens, in which rectilinear distortion is almost completely uncorrected.

Generally, the fisheye lens photographs a circular image having an angle of view of 180 degrees.

Since the fisheye lens is used as the lens unit 3700 of the embodiment, therefore, a wider scene may be displayed to the user.

The outer cover 3300 of the embodiment may be formed in various shapes.

More specifically, the outer cover may be formed in the shape of a curved surface. Alternatively, the outer cover may be formed in the shape of a flat surface. The outer cover may be formed in various shapes as needed.

Since the outer cover defines the external appearance of the head-mounted display apparatus for implementing virtual reality according to the embodiment, the aesthetics of the outer cover are considered.

The camera unit 3900 of the embodiment may be configured to photograph a scene identical to the scene viewed by the user such that the photographed scene is displayed on the display unit 3000.

More specifically, the camera unit 3900 may include a first camera 3910 provided on the right side of the body 3100 so as to correspond to the right eye of the user and a second camera 3930 provided on the left side of the body 3100 so as to correspond to the left eye of the user.

The first camera 3910 may be configured to have a first wide angle A, and the second camera 3930 may be configured to have a second wide angle B.

The first wide angle A and the second wide angle B may be the same as each other.

Alternatively, the first wide angle A and the second wide angle B may be different from each other.

However, the above construction is given only to describe one embodiment. The position at which the camera unit 3900 is mounted and the number of cameras may be varied as needed. It is sufficient for the camera unit 3900 to photograph a scene identical to the external scene viewed by the user. Furthermore, however, the scope of rights of the disclosure is not limited thereto.

The display unit 300 may be configured to display the image photographed by the camera unit 3900 and an image provided by an information provision unit 450 such that the user can view the images.

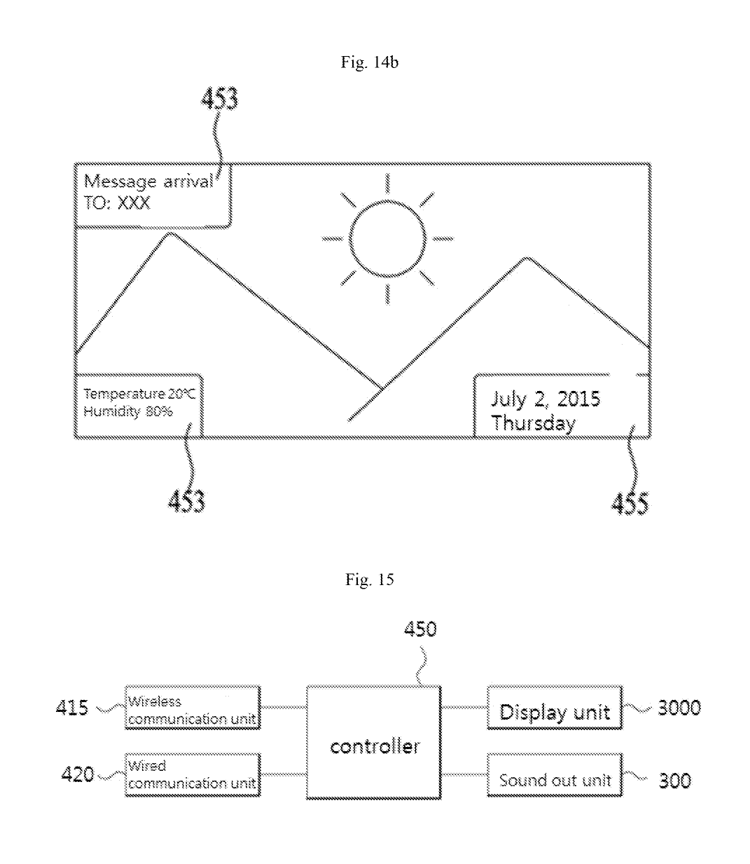

FIGS. 14a and 14b are views showing a scene displayed to the user through the head-mounted display apparatus for implementing virtual reality of FIG. 13.

FIG. 14a shows a scene photographed by the camera unit 3900, which is disposed at one surface of the head-mounted display apparatus for implementing virtual reality according to the embodiment.

As described above, the camera unit 3900 may be configured to photograph a scene identical to the scene viewed through the eyes of the user and to display the photographed scene on the display unit 3000.

For example, the first camera 3910 may photograph a scene viewed through the left eye of the user, and the second camera 3930 may photograph a scene viewed through the right eye of the user.

A controller 450 may transmit a first image signal photographed by the first camera 3910 and the second camera 3930 to the display unit 3000, on which the first image signal is displayed.

Subsequently, an information provision unit 450 of the embodiment may further display various kinds of second image information necessary for the user on the displayed first image signal in an overlapping fashion.

For example, as shown in FIG. 3(b), the information provided by the information provision unit 450 may be information about a message received by a mobile phone.

In addition, the information provided by the information provision unit 450 may be information about the current temperature and humidity.

In addition, the information provided by the information provision unit 450 may be information about the current date.

That is, the information provision unit 450 of the embodiment may include a first information provision part 451 for providing information about a message received by a mobile phone, a second information provision part 453 for providing information about the current temperature and humidity, and a third information provision part 455 for providing information about the current date.

However, the information provision unit 450 may transmit information necessary for the user to the display unit 3000, on which the information is displayed, in addition to the second image information. Consequently, the information provision unit 450 is not limited to the above embodiment.

FIG. 15 is a block diagram showing the structure of the head-mounted display apparatus for implementing virtual reality of FIG. 13.

Referring to FIG. 15, the head-mounted display apparatus for implementing virtual reality according to the embodiment may include a wireless communication unit 410 for exchanging various kinds of control signals using a wireless communication protocol, such as Bluetooth or a wired communication unit 420 for exchanging a signal with another control device, a display unit 3000 for displaying a scene photographed by the camera unit 3900 and information provided by the information provision unit 450, a sound output unit 440 for outputting an announcement or an alarm, and a controller 450 for controlling the above components and performing determinations and operations required to control the head-mounted display apparatus for implementing virtual reality according to this embodiment.

For example, the controller 450 may transmit information and sound provided by the camera unit 3900 and the information provision unit 450 to the display unit 3000 and the sound output unit 440 such that the information can be output through the display unit 3000 and/or the sound output unit 440.

Of course, the structure of FIG. 15 is illustrative. It will be obvious to those skilled in the art that a larger number or a smaller number of components may be included as needed.

Although embodiments have been described with reference to a number of illustrative embodiments thereof, it should be understood that the embodiments are illustrative and not restrictive, and that numerous other modifications and applications may be devised by those skilled in the art that will fall within the intrinsic aspects of the embodiments. For example, various variations and modifications are possible in concrete constituent elements of the embodiments. In addition, it is to be understood that differences relevant to the variations and modifications fall within the spirit and scope of the present disclosure, which is defined in the appended claims.

### MODE FOR INVENTION

Various embodiments have been described in the best mode for carrying out the invention.

### INDUSTRIAL APPLICABILITY

The lens, the optical device, and the head-mounted display apparatus for implementing virtual reality including the same according to the embodiments may be used to implement virtual reality and augmented reality. The volume of the lens may be reduced. The angle of view of the optical device may be increased while the weight and volume of the optical device are reduced.

1. A lens comprising:
a first surface; and
a second surface opposite the first surface, wherein
the second surface comprises a plurality of optical path conversion units,
each of the optical path conversion units comprises a first part and a second part having different inclinations with respect to a first axis perpendicular to the first surface, and
a height of an optical path conversion unit disposed at a central part of the second surface in a first-axis direction is different than a height of an optical path conversion unit disposed at a peripheral part of the second surface in the first-axis direction,
wherein the optical path conversion units have a same center, and the same center is spaced apart from a center of the second surface.

2. The lens according to claim 1, wherein each of the optical path conversion units has a circular shape.

3. (canceled)

4. The lens according to claim 1, wherein the first part is parallel to the first axis.

5. The lens according to claim 1, wherein the second part has a curvature.

6. The lens according to claim 1, wherein the height of each of the optical path conversion units gradually increases from the central part to the peripheral part.

7. The lens according to claim 1, wherein the optical path conversion units constitute concentric circles.

8. The lens according to claim 6, wherein the lens comprises a pair of lenses, and centers of the optical path conversion units of the lenses are spaced apart from each other in opposite directions.

9. The lens according to claim 1, wherein widths of the optical path conversion units are uniform.

10. The lens according to claim 1, wherein each of the optical path conversion units has a width of 10 μm to 1 mm.

11. The lens according to claim 1, wherein each of the optical path conversion units has a height of 0.5 mm or less.

12. (canceled)

13. An optical device comprising:
at least two lenses, each comprising a first surface and a second surface opposite the first surface, wherein the second surface comprises a plurality of optical path conversion units, each of the optical path conversion units comprises a first part and a second part having different inclinations with respect to a first axis perpendicular to the first surface, and a height of an optical path conversion unit disposed at a central part of the second surface in a first-axis direction is different than a height of an optical path conversion unit disposed at a peripheral part of the second surface in the first-axis direction; and
a fixing holder for fixing the lenses, wherein
the fixing holder comprises a location part for allowing a display unit to be disposed thereon, and
wherein optical axes of the lenses are inclined with respect to each other.

14. The optical device according to claim 13, wherein a size of each lens is equal to or less than a size of the display unit.

15. The optical device according to claim 13, wherein a distance from the first surface of each lens to the display unit is less than ⅔ of a size of the display unit.

16. (canceled)

17. The optical device according to claim 13, wherein the display unit comprises two display units, and the display units are disposed so as to be perpendicular to optical axes of the lenses.

18. The optical device according to claim 17, wherein the optical axes of the lenses are inclined such that an angle between the optical axes is 60 degrees or less.

19. A head-mounted display apparatus for implementing virtual reality comprising:
at least two lenses, each comprising a first surface and a second surface opposite the first surface, wherein the second surface comprises a plurality of optical path conversion units, each of the optical path conversion units comprises a first part and a second part having different inclinations with respect to a first axis perpendicular to the first surface, and a height of an optical path conversion unit disposed at a central part of the second surface in a first-axis direction is different than a height of an optical path conversion unit disposed at a peripheral part of the second surface in the first-axis direction;
a display unit disposed so as to be spaced apart from the second surface of each lens;
a fixing holder for fixing each lens to the display unit;
a circuit board for supplying a signal to the display unit; and
a main body for receiving the fixing holder and the circuit board therein,
wherein optical axes of the lenses are inclined with respect to each other.

20. (canceled)

21. The optical device according to claim 13, wherein the optical path conversion units have a same center.

22. The optical device according to claim 21, wherein the same center is spaced apart from a center of the second surface.

23. The head-mounted display apparatus for implementing virtual reality according to claim 19, wherein the optical path conversion units have a same center.

24. The head-mounted display apparatus for implementing virtual reality according to claim 19, wherein the same center is spaced apart from a center of the second surface.
